(19) United States
(12) Patent Application Publication
(10) Pub. No.: US 2009/0139416 A1
(43) Pub. Date: Jun. 4, 2009

(54) PRINTER

(75) Inventor: Stefan Wagler, Rebstein (CH)

Correspondence Address: VOLPE AND KOENIG, P.C., UNITED PLAZA, SUITE 1600, 30 SOUTH 17TH STREET, PHILADELPHIA, PA, 19103, US

(73) Assignee: ZUND SYSTEMTECHNIK AG, Altstatten (CH)

(21) Appl. No.: 11/719,257

(22) PCT Filed: Nov. 23, 2005
(86) PCT No.: PCT/CH05/00689

§ 371 Date: Nov. 28, 2008

(30) Foreign Application Priority Data
Nov. 23, 2004 (CH) 1922/04

(51) Int. Cl. B41F 5/00

(52) U.S. Cl. 101/216

(57) ABSTRACT

A printer (1) is provided having two spaced apart pinions (29) that intermesh with two racks (31) which form frame elements of a stereotype printing assist system or which are fastened to the bottom side of the frame elements of the stereotype printing assist system. The pinions (29) allow movement of the stereotype printing assist system forwards and backwards true to the real position thereby allowing a reproducible overprint or overprinting of small sized products (19) to be imprinted using an one-dimensionally mobile print head unit (3).

### BACKGROUND

The subject of the invention is a printer for printing sheets, plates, and endless roll materials according to the preamble of claim 1.

Printers of this class are known. They are used for printing on large surface-area plates made from metal, plastic, or wood, sheets or endless roll materials, such as paper, textiles, films, etc.

The known printers comprise a housing with a printing table or a printing surface, above which a print head unit is supported so that it can be driven along a straight track and also so that it can be lowered onto or moved away from the work piece for printing. A printer of this class further comprises at most one or two transport cylinders, which advance the printing material through frictional contact.

With such printers, endless roll material can be printed on. The printing direction or forward feed direction of the endless roll material is always the same. Instead of endless roll material, plates lying on the transport cylinder or cylinders can also be printed on. An overprint, for example, of a white pre-print with ink, is not possible with the necessary accuracy, because neither the endless roll material nor the plates lying on the transport cylinders can be guided with sufficient accuracy forwards and backwards under the print head unit.

Printing systems that can move with positional accuracy are also known. In these systems, either the print head unit can be moved together with its guide over the work piece, which is held fixed on the printing table, or the entire printing table is constructed so that it can move under the print head unit. The latter devices are built for the most part as single-purpose machines and cannot be converted for printing on endless roll materials. In addition, the masses of the printing table or the print head unit together with their guides are relatively large, so that only small travel speeds are possible.

### SUMMARY

One objective of the present invention now consists in constructing a printer such that printing can be performed on this work piece with absolute positional accuracy, wherein, in particular, small-format objects and also overprints can be performed in a reproducible way. In addition, the printing of endlessly fed, web-shaped material, such as films, etc., should also be possible on the printer.

This objective is met by a printer according to the features of claim 1. Especially advantageous constructions of the printer are transcribed in the dependent claims.

A holder frame, which is connected to a forward feed drive via a positive-fit connection and which is used as a plate printing aid, allows the printing material to be guided with absolute precision and reproducible overprints to be produced on a conventionally built printer used for printing on endlessly fed material. The holder frame can be moved not only precisely in a forward feed direction, but also in two directions, so that overprinting becomes possible. The driving means necessary for driving the holder frame do not interrupt the conventional printing of endless material webs or plate-shaped work pieces that lie on a transport roller and that can be advanced frictionally engaged only in one transport direction. Conventional printers can be converted or retrofitted with very minimal technical and financial expense by adding drive means entering into a positive fit with the holder frame at the end sides of the transport cylinder or at a different position and are used as printers for reproducible prints or printing on small-format print carriers.

Through the arrangement of ink print heads with at least one white print head arranged in series with these other print heads, a prior white print or a subsequent white print or subsequent treatment of the area to be printed, for example, with a coating can be performed. With UV dryers arranged at the end relative to the print heads, prints can be produced economically and with low energy expense, because the UV dryer must cover only the width of one print head. The printing of small plates, which cannot be held by the transport cylinders, can be performed individually or simultaneously.

The removal and the loading of objects to be printed on by the printer can always be performed from the same side of the machine (front or back).

### BRIEF DESCRIPTION OF THE DRAWINGS

The invention is explained in more detail with reference to an illustrated embodiment. Shown are

FIG. 1 a schematic cross sectional view through a printer in an application as a roller printer for endless material,

FIG. 2 a schematic cross sectional view through the printer in an application for single printing on plate-shaped material,

FIG. 3 a schematic cross sectional view through the printer with a plate printing aid for precise printing of plate-shaped materials, after the registration of the plate printing aid and also the printing medium,

FIG. 4 a schematic cross sectional view through the printer with a plate printing aid for precise printing of plate-shaped materials at the beginning of the printing process,

FIG. 5 a schematic cross sectional view through the printer with a plate printing aid for precise printing of plate-shaped materials during the printing process,

FIG. 6 a schematic cross sectional view through the printer with a plate printing aid for precise printing of plate-shaped materials shortly before the end of the printing process,

FIG. 7 a schematic cross sectional view through the printer with a plate printing aid for precise printing of plate-shaped materials after the completion of the printing process,

FIG. 8 a schematic cross sectional view through the printer with a plate printing aid for precise printing of plate-shaped materials for the removal of the printing material,

FIG. 9 a schematic cross sectional view through the printer with a plate printing aid for precise printing of plate-shaped materials after the placement of a new printing material onto the plate printing aid and retracting into the starting position,

FIG. 10 a perspective top view of the printer.

### DETAILED DESCRIPTION OF THE PREFERRED EMBODIMENTS

In the perspective overview illustration according to FIG. 10, the entirety of the printer 1 is designated with the reference symbol 1. This comprises—in addition to a number of additional parts that are not necessary for the understanding of the present invention and that are therefore not described in more detail—a print head unit 3, in which a plurality of print heads 25 are installed in series. At the end on the print head unit 3 there are, for example, two UV dryers 5, which cure the printing inks immediately after the printing process. Between the UV dryers 5 and the ink print heads 25, there can also be a white print head 26. The print head unit 3 is arranged so that it can move on a rail 7 in the direction of the arrows P. The print head unit 3 can also be moved vertically in the direction of the arrows Y. Underneath the rail 7, which is also called a beam, two horizontal drive and transport cylinders 11 and 13 are arranged on a frame in the illustrated example. The two transport cylinders 11, 13 driven by a drive (not shown) are arranged underneath the print head unit 3 such that the nozzles of the print head 25 are directed towards the area between the two parallel transport cylinders 11, 13. In the printing area between the two transport cylinders 11, 13, there is a plate, preferably a vacuum plate 15 as a printing table, on which the material for printing is laid flat. The vacuum plate 15 comprises a box closed on the bottom and on the sides, which is covered by a perforated plate 17 and suctions the material 19 for printing guided by the vacuum plate 15 during the printing process (FIG. 1). In the basic construction of the printer 1 according to FIG. 1, the printing material 19 is an endlessly fed web, which is guided from a feed roll (not shown) over a number of carrier rolls 21 over the first transport cylinder 11. A spring-loaded hold-down roll 23 lies above the first transport cylinder 11. The printing material 19 is guided by the first transport cylinder 11 over the vacuum plate 15 under the print heads 25 with nozzles that are arranged on the bottom side and that are directed towards the printing material 19 to the second transport roller 13, above which a hold-down roll 23 can also be arranged. From there, the printing material 19 now with the print is guided directly or indirectly via carrier rolls 21 to the receiver roll (not shown).

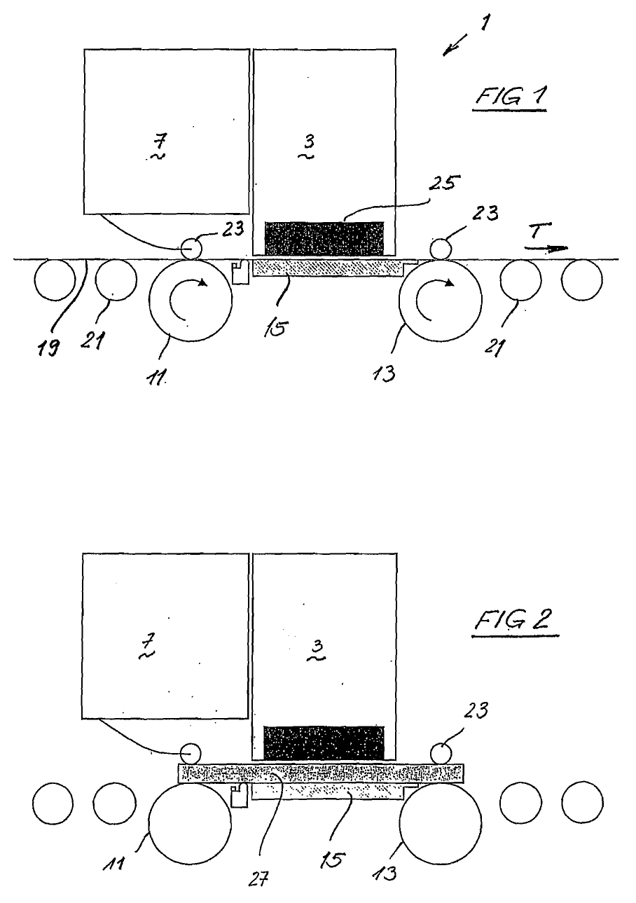

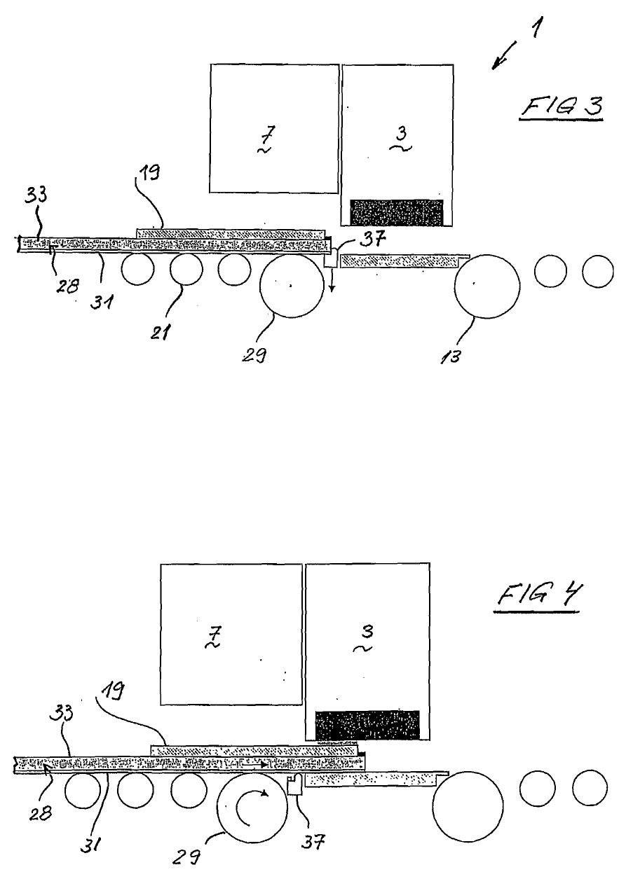

FIG. 2 represents the same printer 1, wherein now the printing material 19 is not fed and transported as an endless web, but instead is composed of a rigid plate 27, which is driven, in turn, by at least one of the transport cylinders 11, 13 under the print head unit 3. Similarly to the endlessly fed printing material 19, the plate 27 can also be transported in a reproducible way by the transport cylinders 11, 13 only in a frictionally engaged connection and only in the direction of the arrow T. Reversing the transport direction, in order to print over certain areas on the printing material 19 or on the plate 27, is not possible due to the inevitable slippage and the associated loss of precision.

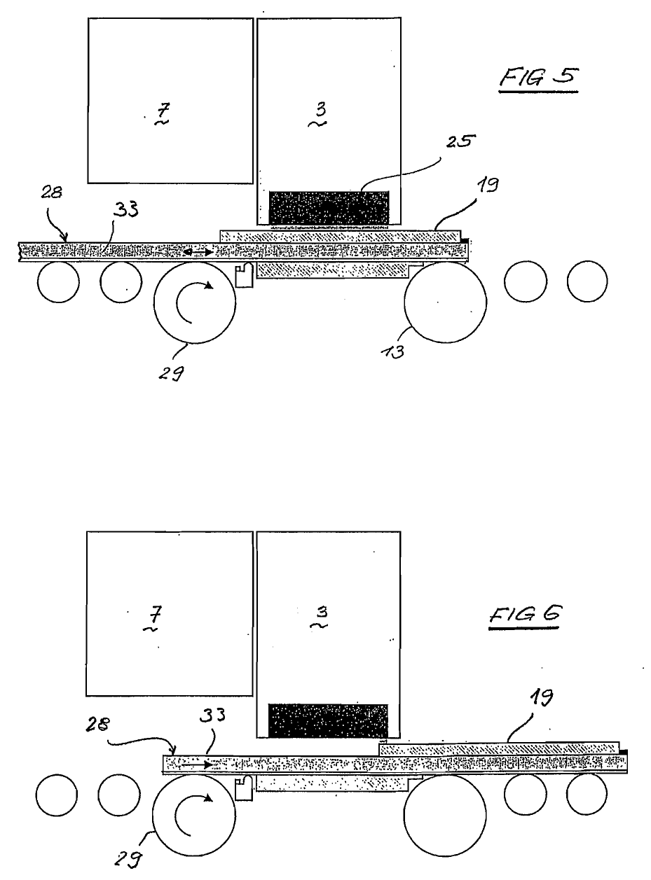

FIGS. 3 to 9 show the same printer 1 with a plate printing aid according to the invention in the shape of a holder frame 28. Toothed pinions 29, which each engage in an intermeshing way with a toothed rack 31, are placed at a distance α on the ends of the first transport cylinder 11. The toothed rack 31 forms either two parallel frame elements 33 of the holder frame 28 lying at a distance α or they are attached to the bottom sides of the frame elements 33 of the holder frame 28. In the schematic representations, the toothed racks 31 are integrated into the frame elements 33.

The holder frame 28 is used as a carrier for a rigid or loose printing material 19, which can be positioned at a stop 35 on the holder frame 28. It is formed as a closed plate, a grating, or the like. Instead of a stop 35, for the positioning or registering of the printing material 19 with respect to the holder frame 28, other means can also be used. The registration of the holder frame 28 with respect to the print heads 25 is performed on a tracer or sensor element 37, which can be lowered after the registration of the position of the holder frame 28. A hold-down roll, which presses onto the top side of the frame elements 33, is not shown in the figures, but guarantees that the positive-fit connection between the toothed pinion 29 and the toothed rack 31 is maintained. The second transport cylinder 13 in this embodiment assumes just a load-bearing function.

After the tracer element 37 is lowered, the holder frame 28 is guided under the print heads 25 together with the printing material 19 driven by the pinion 29. The printing is performed by moving the print head unit 3 along the rail 7, i.e., transverse to the forward feed direction T of the printing material 19 lying on the holder frame 28. Immediately following the printing, the still wet printing ink is dried by one of the UV dryers 5. The effective width of the UV dryers 5 corresponds to the narrow side of the print heads 25, which are arranged one behind the other, i.e., in series, and which are each arranged in front of or behind the UV dryers 5 in the direction of travel P.

In FIG. 5, the printing of the printing material 19 is performed by all of the nozzles of the print head unit 3, i.e., with optimal output. In this figure, it is further visible that very small individual objects for printing, which cannot be guided and clamped tight without the holder frame 28, can now also be printed on with the holder frame 28. If the holder frame 28 is perforated in the contact area with the printing material 19, then the printing material 19 on the holder frame 28 can also be held tight by the vacuum plate 15. Obviously, other means for fixing small and large printing materials 19 can also be used.

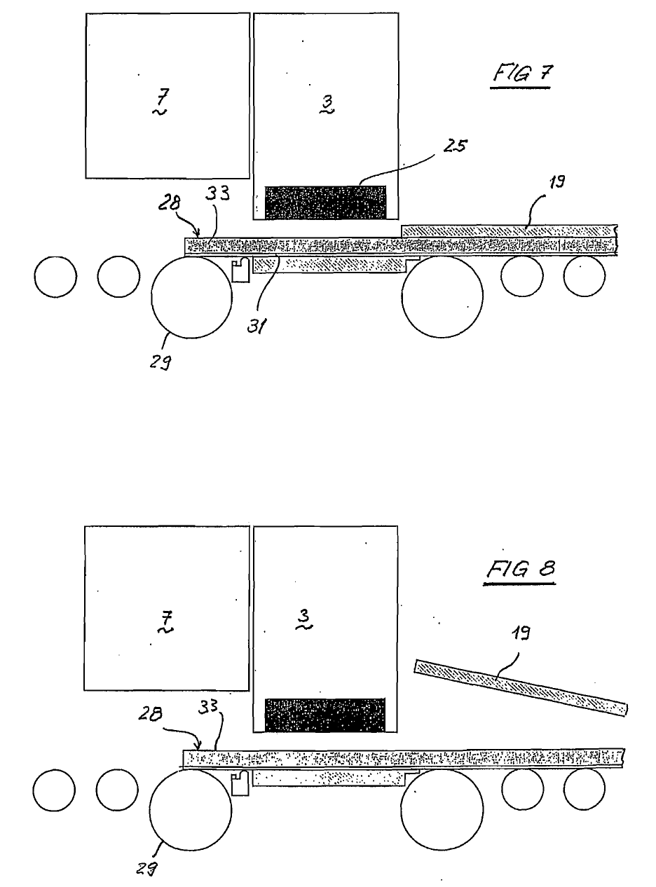

FIG. 6 shows the printing process shortly before completion. From the print heads 25, only a narrow area at the end of the printing material 19 is still to be charged with ink.

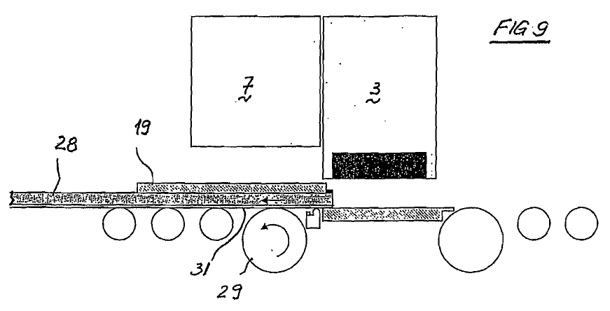

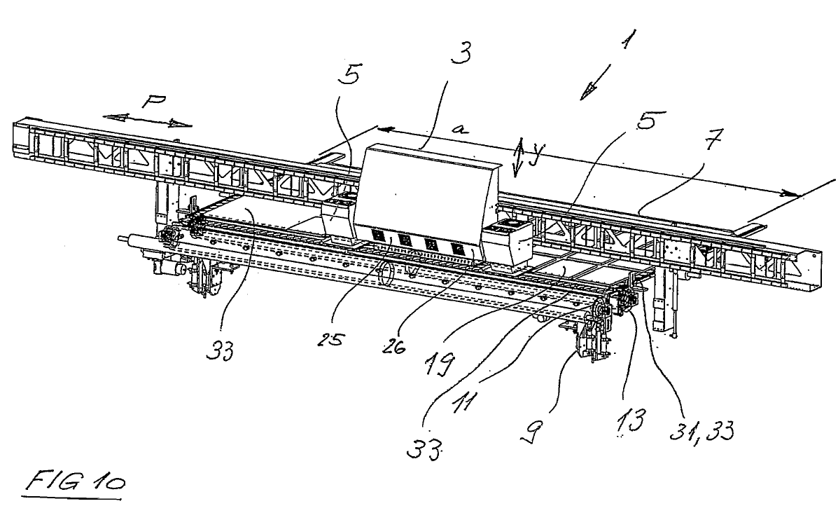

After the end of the printing process according to FIG. 7, the print head unit 3 is moved upwards, i.e., lifted away from the printing material 19. Then the print material 19 can be taken away from the holder frame 28, i.e., removed from the printer 1 and replaced by new printing material 19, which, as soon as it is positioned on the holder frame 28, is guided under the print head 25 towards the rear side of the printer 1. Readjustments to the plate printing aid 28 with respect to the toothed pinion 29 are not necessary, because the engagement of the toothed pinion 29 in the toothed rack 31 has not been disconnected (FIG. 9). Instead of the positive-fit connection between the toothed pinions and toothed racks, another positive-fit connection element can also be used. For example, a punched tape or a track of punched holes can be formed on the holder frame 28, in which the knobs on a knobbed wheel engage. The toothed racks could also be replaced by toothed belts. It is also not absolutely necessary to form the toothed pinion 29 on the shaft of the transport cylinder 11; it could also be arranged at another suitable position. The printer 1 according to the invention can also be operated without transport cylinders for printing on endlessly fed material webs.

All of the motion sequences are controlled by an electronic controller (not shown).

1. Printer (1) for printing on sheets, plates, or endless roll printing materials, comprising a printing area, a print head unit (3), which can be moved over the printing area along a rail (7) on a beam transverse to a forward feed direction (T) of the printing material (19), and also an electronic controller for controlling a transport means (11, 13) for the printing material, travel movements of the print head unit (3), and also print heads (25) arranged on the print head unit (3), two drive wheels (29) that extend an axial distance (a) and that can be driven are arranged in the printing area and are suitable and constructed such that means (31), which are arranged in parallel and at a distance (a) to the drive wheels (29), which lie above the printing area, and which are equipped for a positive-fit engagement of the drive wheels (29), engage a holder frame (28) used as a plate printing aid with a positive fit.

2. Printer according to claim 1, wherein toothed pinions or knobbed wheels are used as the drive wheels (29).

3. Printer according to claim 2, wherein the means (31) on the holder frame (28) comprise toothed racks, toothed belts, or punched tapes.

4. Printer according to claim 1, wherein characterized in that the holder frame (28) is constructed as comprises a closed plate, a perforated plate, or a grating.

5. Printer according to claim 3, wherein the means (31) comprises the toothed racks arranged as a pair, and the toothed rack pair (31) lies at an apex of a transport cylinder (13).

6. Printer according to claim 2, wherein hold-down rolls roll down on the holder frame (33) from above to form a contact above the toothed pinions (29).

7. Printer according to claim 1, wherein in the printing area at least one sensor or tracer element (37) that can move vertically is arranged for tracing and positioning the holder frame (28).

8. Printer according to claim 1, wherein in the print head unit (3), the print heads (25) are for ink and are arranged in series in a direction of motion (P) of the print head unit (3) and at least one white print head (39) is also arranged in series relative to the print heads.

9. Printer according to claim 8, wherein a UV dryer (5), whose effective width (b) extends at least over a printing width (B) of the print heads (25, 39), is arranged on at least one narrow side of the print heads (25, 39) lying in series.

10. Printer according to claim 1, wherein the drive wheels (29) are constructed or arranged on ends of a transport cylinder (11).
